(19) United States
(12) Patent Application Publication
(10) Pub. No.: US 2026/0168679 A1
(43) Pub. Date: Jun. 18, 2026

(54) FACILITY HEATING DEVICE AND METHOD USING ELECTRIC VEHICLE CHARGER HEAT SOURCE

(71) Applicants: Hyundai Motor Company, Seoul (KR); Kia Corporation, Seoul (KR)

(72) Inventors: Jeawan Kim, Hwaseong-Si (KR); Jungmo YU, Hwaseong-Si (KR)

(21) Appl. No.: 19/316,684

(22) Filed: Sep. 2, 2025

(30) Foreign Application Priority Data
Dec. 13, 2024 (KR) 10-2024-0185594

(51) Int. Cl. F24D 15/02; F28D 20/02; G05B 15/02

(52) U.S. Cl. CPC F24D 15/02; F28D 20/02; G05B 15/02; F24D 2200/29

(57) ABSTRACT

A facility heating method uses an electric vehicle charger as a heat source. The facility heating method includes: determining whether a facility uses/requires heating; determining whether a charger is available as a heat source; determining whether a phase change material (PCM) is available as a heat source; and when the facility uses heating, using at least one of the heat sources of the charger and the heat source of the PCM for the heating of the facility.

### CROSS-REFERENCE TO RELATED APPLICATION

This application claims priority to and the benefit of Korean Patent Application No. 10-2024-0185594 filed with the Korean Intellectual Property Office on December 13, 2024, the entire contents of which are incorporated herein by reference.

### TECHNICAL FIELD

The present disclosure relates to a facility heating device and method using an electric vehicle charger heat source, and more particularly, to a facility heating device and method for heating a facility using an electric vehicle charger heat source using heat generated by a charger.

### BACKGROUND

As the power performance and battery capacity of an electric vehicle are improved, a charging power of an electric vehicle charger is also expected to be improved. The charging power of the charger may be improved by, for example, stacking power conversion modules. However, stacked power conversion modules generate heat, so thermal management inside the charger becomes important. In order to secure charging stability, many studies have been conducted to design a cooling system that maintains the temperature of the power conversion module (e.g., at a temperature equal to or lower than an allowable temperature). However, there have been very few attempts to utilize the power conversion module as a heat source.

Electricity generates heat by movement of positive (+) and negative (-) . The heat is generated by resistance to movement of electric charges. As the resistance is converted to heat, energy loss occurs. Higher heat may be generated depending on the amount of voltage (V) and current (A). The thickness of wires for slow chargers is very thin/narrow compared to that of fast chargers. Compared to fast charging, slow charging has relatively low current and voltage, so the resistance is also small and less heat is generated.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for heating a facility using an electric vehicle charger heat source. A method for providing heat to a facility associated with a charger for an electric vehicle may comprise: receiving a signal indicating a heating load of the facility; determining whether the charger is available as a heat source; determining whether a phase change material (PCM) is available as a heat source; based on the indicated heating load and at least one of the charger or the PCM being available as at least one heat source, selecting at least one of the charger or the PCM as a heat source for the heating load; and transferring heat energy from the selected at least one of the charger or the PCM to the facility.

A facility heating device configured to control use of heat energy from charger of an electric vehicle for heating a facility may comprise: one or more processors; and one or more memory devices storing a program code, wherein the program code, when executed by the one or more processors, is configured to cause the facility heating device to: receive a signal indicating a heating load of the facility; determine whether a charger is available as a heat source, determine whether a phase change material (PCM) is available as a heat source, based on the indicated heating load and at least one of the charger or the PCM being available as at least one heat source, select at least one of the charger or the PCM as a heat source for the heating load; and transfer heat energy from the at least one of the charger or the PCM to the facility.

A system may comprise: a charger for charging electric vehicles; a phase change material (PCM) configured to receive heat from the charger; one or more heat exchangers configured to exchange heat with the charger or the phase change material and provide the exchanged heat to a facility; and a facility heating device comprising: one or more processors; and one or more memory devices storing a program code, wherein the program code, when executed by the one or more processors, is configured to cause the facility heating device to: receive, from a sensor associated with the facility, a signal indicating a heating load of the facility; determine whether at least one of the charger or the PCM is available as a heat source; and based on the indicated heating load and the at least one of the charger or the PCM being available as the heat source: setting the at least one of the charger or the PCM as the heat source; coupling the at least one of the charger or the PCM to the heating load for heat transfer; and controlling the one or more heat exchangers to exchange heat with the at least one of the charger or the PCM and provide the exchanged heat to the facility to satisfy the heating load.

These and other features and advantages are described in greater detail below.

### BRIEF DESCRIPTION OF THE DRAWINGS

FIG. 1 is a diagram schematically illustrating a facility heating system using an electric vehicle charger heat source according to an example of the present disclosure.

FIG. 2 is a circuit diagram illustrating an operation of a system through a facility heating device using an electric vehicle charger heat source according to an example of the present disclosure.

FIG. 3 is a flowchart of a facility heating method using an electric vehicle charger heat source according to an example of the present disclosure.

FIGS. 4, 5A, 5B, 6, 7, 8, and 9 are circuit diagrams for describing the facility heating method using the electric vehicle charger heat source according to the example of the present disclosure.

FIG. 10 is a diagram illustrating a computing device according to an example of the present disclosure.

### DETAILED DESCRIPTION

Hereinafter, the present disclosure will be described more fully hereinafter with reference to the accompanying drawings showing various examples of the present disclosure. As those skilled in the art would realize, the described examples may be modified in various different ways without departing from the spirit or scope of the present disclosure. Accordingly, the drawings and description are to be regarded as illustrative in nature and not restrictive. Like reference numerals designate like elements throughout the specification and drawings.

Throughout the specification and the claims, unless explicitly described to the contrary, the words “comprise”, “has”, “include”, and variations thereof, will be understood to indicate the inclusion of stated elements but not the exclusion of any other elements. Terms including an ordinary number, such as first and second, A and B, etc., are used for describing various constituent elements, but the constituent elements are not limited by the terms. The terms are used only to discriminate one constituent element from another constituent element.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B. “One or more of” is synonymous with “at least one of” herein.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

Unless otherwise defined, the terms used herein, including technical or scientific terms, may have meanings generally understood by those skilled in the art to which the present disclosure belongs.

The expression "based on" as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is "connected" or "coupled" to another component (e.g., a second component) as used herein, it may mean that the component is not only directly connected or coupled to another component, but also connected or coupled through yet another component (e.g., a third component).

Depending on the context, the expression "configured to" as used herein may have meanings such as "set to", "with the ability to", "modified to", "made to", "to be able to", etc. This expression is not limited to the meaning of "specially designed in hardware to". For example, a processor configured to perform a specific operation may refer to a generic purpose processor capable of performing the specific operation by executing software, or to a special purpose computer structured through programming to perform the specific operation.

Hereinafter, examples of the present disclosure will be described in detail with reference to the accompanying drawings.

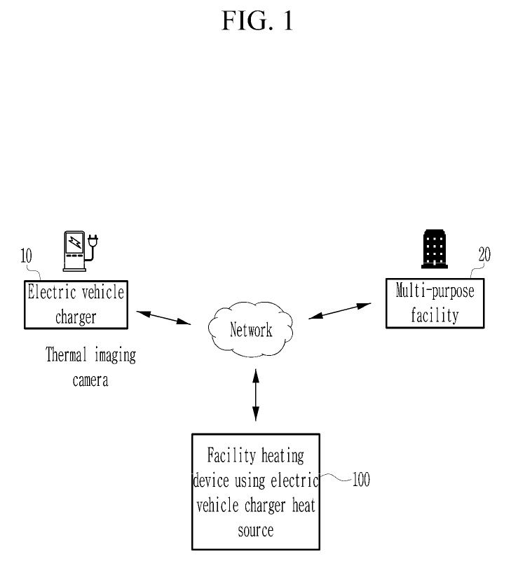

FIG. 1 is a diagram schematically illustrating a facility heating system using an electric vehicle charger heat source according to an example of the present disclosure.

A facility heating system using an electric vehicle charger heat source includes an electric vehicle charger 10, a multi-purpose facility 20, and a facility heating device 100 using the electric vehicle charger heat source.

The electric vehicle charger 10, the multi-purpose facility 20, and the facility heating device 100 using the electric vehicle charger heat source may be connected through/via a network (e.g., a wired and/or wireless communication network, such as a personal area network (PAN), a Local Area Network (LAN), a cloud network, a virtual private network (VPN), an enterprise private network (EPN), a wide area network (WAN), etc.).

The electric vehicle charger 10 may include at least one electric vehicle charger (e.g., disposed at a charging station).

The electric vehicle charger 10 may generate a high-temperature heat source and/or heat energy (e.g., when charging an electric vehicle).

The multi-purpose facility 20 may include a convenience facility and/or a rest facility. The multi-purpose facility 20 may be a facility provided and/or associated with a charging station including the electric vehicle charger 10.

That is, the multi-purpose facility 20 may be a facility that a driver may use while charging a vehicle with/via the electric vehicle charger 10. The multi-purpose facility 20 may be located adjacent and/or near to the electric vehicle charger 10 (e.g., on a same premises as the electric vehicle charger 10). For example, the charging station may include the electric vehicle charger 10 and the multi-purpose facility 20, and may serve as a space for the driver's rest while charging the electric vehicle.

The facility heating device 100 using the electric vehicle charger heat source may supply power generated by the operation of a charging station by using eco-friendly energy or discarded energy in consideration of the global environment.

In other words, the facility heating device 100 using the electric vehicle charger heat source may supply power for the operation of the multi-purpose facility 20 of the charging station. The supplied power may be based on the heat source/energy generated by the electric vehicle charger during charging.

The facility heating device 100 using the electric vehicle charger heat source according to the example may comprise one or more processors configured to execute a program code or one or more instructions stored in one or more memory devices.

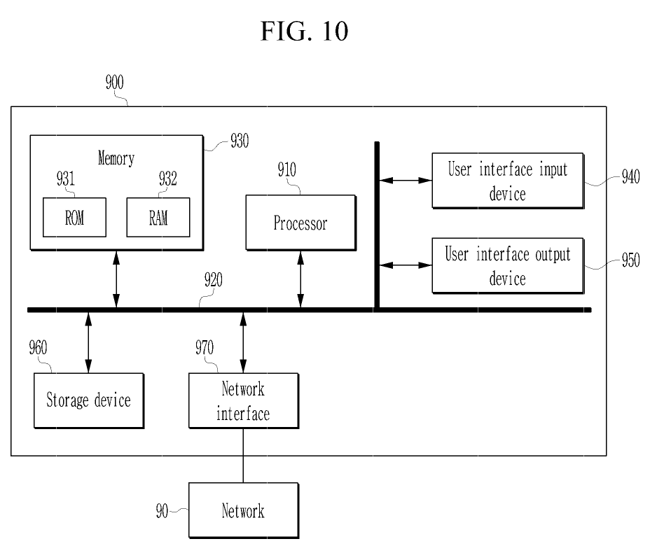

For example, the facility heating device 100 using the electric vehicle charger heat source may be implemented as/comprise a computing device 900 (e.g., as described herein with reference to FIG. 10). One or more processors may correspond to a processor 910 of the computing device 900, and one or more memory devices may correspond to a memory 930 of the computing device 900. The program code or instruction may be executed by the one or more processors to cause/control use of a (e.g., high-temperature) heat source from the electric vehicle charger 10 (hereinafter, the charger) as heat energy for heating the multi-purpose facility 20.

The facility heating device 100 using the electric vehicle charger heat source may be implemented as/to comprise a controller (e.g., control computing device, etc.) that performs the functions including the computing device 900.

In the example, the facility heating device 100 using the electric vehicle charger heat source may heat/cause heating of the multi-purpose facility 20 (and/or provide heat for one or more components thereof) using a high-temperature heat source generated by the electric vehicle charger 10.

The facility heating device 100 using the electric vehicle charger heat source may determine whether to provide heat to the facility (e.g., whether the facility and/or a component thereof requires/requests heating).

The facility may include at least one multi-purpose facility 20 (e.g., which is adjacent to the charger 10). The multi-purpose facility 20 may include a rest facility and/or a sales facility. The multi-purpose facility 20 may be installed indoors or outdoors (e.g., be enclosed and/or open to the outdoors).

The facility heating device 100 using the electric vehicle charger heat source may determine whether the facility has at least one heating load in order to determine whether to provide heat to the facility.

The facility heating device 100 using the electric vehicle charger heat source may determine that the facility has the at least one heating load based on the outside temperature of the facility satisfying specific temperature threshold (e.g., if/when the outside temperature of the facility is lower than a specific temperature).

The facility heating device 100 using the electric vehicle charger heat source may determine whether the charger is available as a heat source of the charger.

The facility heating device 100 using the electric vehicle charger heat source may determine that the charger is available as heat source based on a temperature of the charger satisfying a temperature threshold (e.g., when a temperature of the charger reaches a specific temperature or higher while the charging station is charging the electric vehicle). The specific temperature may be a preset temperature (e.g., input by a user).

The facility heating device 100 using the electric vehicle charger heat source may determine whether a phase change material (PCM) is available as a heat source. For example, the PCM (phase change material) may be a mixture of lauric acid, palmitic acid, and stearic acid.

The PCM may be part of a heat exchanger (e.g., a heat exchange device). For example, the heat exchanger may be capable of/configured to storing heat energy by using/based on characteristics of the phase change material.

The facility heating device 100 using the electric vehicle charger heat source may determine whether sufficient heat energy is stored in the PCM.

The facility heating device 100 using the electric vehicle charger heat source may determine that sufficient heat energy is stored in the PCM based on determining a temperature of the PCM satisfies a threshold (e.g., when/if the temperature of the PCM is higher than or equal to the reference temperature). For example, the reference temperature may be a preset temperature (e.g., an input/predetermined temperature) and/or may be variable.

The facility heating device 100 using the electric vehicle charger heat source may use at least one of the charger or the PCM as at least one heat source for heating the facility (e.g., based on the facility having at least one heating load and/or when/if the facility uses heating).

The facility heating device 100 using the electric vehicle charger heat source may store heat energy in the PCM by using the charger as a heat energy source. The PCM may be used to store the heat energy based on the charger being available as a heat source and based on the facility not using/needing heating (e.g., when/if the heat source of the charger is available and the facility does not use/need heating).

The facility heating device 100 using the electric vehicle charger heat source may use the PCM as the heat source for heating the facility based on the charger not being available as a heat source and based on the facility not needing/using heating (e.g., when it is determined that the charger is not available as a heat source and that/when/if the facility uses/requires/requests heating (has a heating load)).

The facility heating device 100 using the electric vehicle charger heat source may discharge heat from the charger and/or the PCM (e.g., to the outside/environment) when/if the facility does not need to use/require heating.

The facility heating device 100 using the electric vehicle charger heat source may use an alternative heating source (e.g., heater/radiator/etc.) disposed in the facility for heating when/if the facility uses/requires/requests heating, and when/if both the charger and/or the PCM are not available as heat sources.

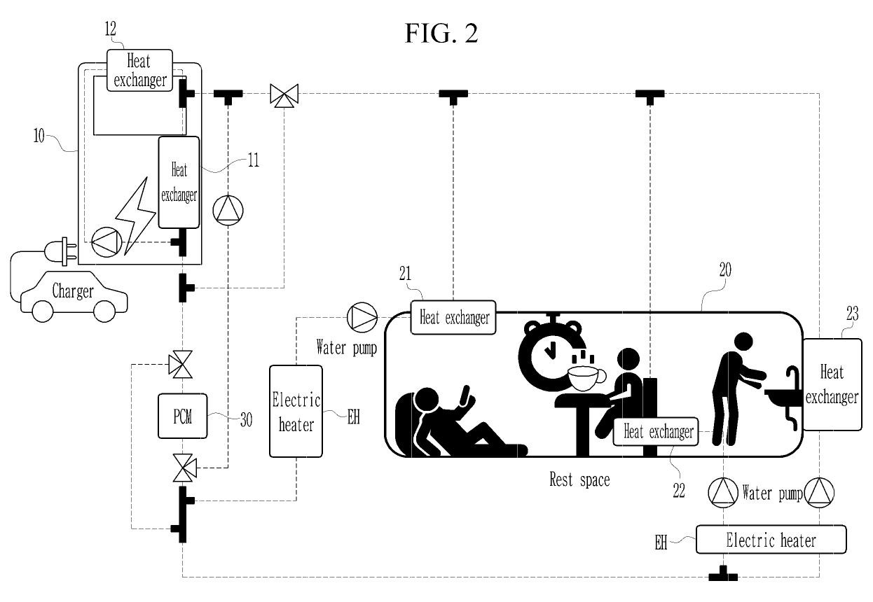

FIG. 2 is a circuit diagram illustrating a system comprising the facility heating device using the electric vehicle charger heat source according to the example of the present disclosure.

The facility heating device 100 using the electric vehicle charger heat source may control a heat source and/or heat energy moving between at least one first heat exchanger (e.g., first and second heat exchangers 11 and 12) in the charger 10 and at least one second heat exchanger (e.g., third, fourth and fifth heat exchangers 21, 22 and 23) in the facility 20 (e.g., according to the circuit diagram of FIG. 2).

The facility heating device 100 using the electric vehicle charger heat source may include a controller that is communicatively connected to the charger 10 and/or the multi-purpose facility 20 of FIG. 2 (e.g., via a wired/wireless network). The controller may be configured to control the charger 10, the PCM 30 disposed in the charger 10, the multi-purpose facility 20, and/or one or more electric heaters EH arranged in the multi-purpose facility 20.

In FIG. 2, the charger 10 may include first and second heat exchangers 11 and 12. The first and second heat exchangers 11 and 12 may allow for movement of heat produced by the charger 10 to the multi-purpose facility 20 and/or the PCM 30.

The multi-purpose facility 20 may include third to fifth heat exchangers 21, 22, and 23. The third to fifth heat exchangers 21, 22, and 23 may receive a heat source from the charger 10 and/or the PCM 30 and use/allow for use of the received heat source for heating the multi-purpose facility 20.

At least one electric heater EH may be provided to supply heat to at least one heat load (e.g., heat air, heat water, etc.) required for heating the multi-purpose facility 20.

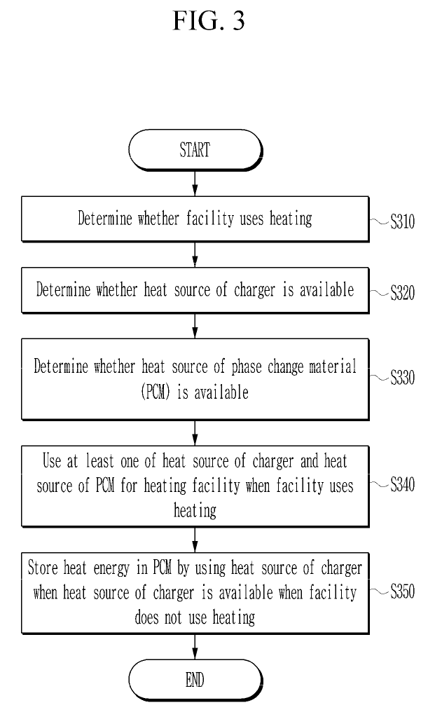

FIG. 3 is a flowchart of a facility heating method using an electric vehicle charger heat source according to an example of the present disclosure. The facility heating method using an electric vehicle charger heat source in FIG. 3 may be performed by/via the facility heating device 100 (see FIG. 1) using the electric vehicle charger heat source.

For convenience, FIG. 3 is described by way of an example in which the steps are performed by a processor circuit. One, some, or all steps of the example method of FIG. 3, or portions thereof, may be performed by one or more other circuits. One or some, steps of the example method of FIG. 3 may be omitted, performed in other orders, and/or otherwise modified, and/or one or more additional steps may be added.

The facility heating device 100 using the electric vehicle charger heat source may control the first to fifth heat exchangers 11, 12, 21, 22, and/or 23, the electric heater EH, and/or the water pumps to control the heating of the multi-purpose facility 20 based on/via the charger 10 as a heat source.

In FIG. 3, the facility heating device 100 using the electric vehicle charger heat source may determine whether the facility uses/requires heating (S310).

In S310, the facility heating device 100 using the electric vehicle charger heat source may determine whether the facility has at least one heating load. For example, the facility heating device 100 using the electric vehicle charger heat source may determine whether the facility has at least one heating load based on receiving a signal indicating a heating load of the facility

The heating load may refer to indoor heating (e.g., of a rest space included in the facility), hot water supply (e.g., to an indoor and/or outdoor bench/sink, hot water supply to a rest space, etc.), and the like.

For example, in winter (and/or if/when the outside temperature is low), it may be determined that the facility has a heating load (e.g., based on the external temperature and a determination that there is indoor heating, bench hot water supply, and/or rest area hot water use, etc.).

If/when the temperature of the indoor space of the facility rises (e.g., to a threshold indoor temperature) and/or the temperature of the hot water rises (e.g., to a threshold hot water temperature), the heating load may decrease or disappear (e.g., a determination may be made that the heating load has decreased and/or does not exist/no longer exists).

The facility heating device 100 using the electric vehicle charger heat source may determine that the facility uses/requires/requests heating when/if the outside temperature of the facility is lower than a predetermined specific temperature (e.g., threshold external/environmental temperature). Also, or alternatively, the facility heating device 100 using the electric vehicle charger heat source may determine that the facility uses/requires/requests heating when/if an internal temperature is lower than a predetermined specific temperature (e.g., threshold indoor temperature) and/or a water temperature is lower than a predetermined specific temperature (e.g., threshold water temperature). For example, the facility heating device 100 may receive temperature information (e.g., temperature measurements and/or indications that a measured temperature satisfies (e.g., is lower than or equal to) a temperature threshold, etc.) from one or more thermometers/temperature sensors configured to measure the outside temperature, indoor temperature, water temperature, etc. The facility heating device 100 may determine based on the received temperature information (e.g., in a received signal indicating the at least one heating load) that the facility uses/requires heating. In another example, the determining whether the facility uses heating (S310) may also, or alternatively, be based on an indication (e.g., in a received signal indicating the at least one heating load) that a user of the facility is in and/or near a space to be heated and/or is using a hot water source of the facility. For example, the facility may determine occupancy of the facility via a camera (e.g., performing object recognition) an occupancy/motion detector, a sensor indicating activation of a hot water faucet, etc.

The facility heating device 100 using the electric vehicle charger heat source may determine whether the charger is available as a heat source (S320). The facility heating device 100 using the electric vehicle charger heat source may determine, based on determining that the facility uses/requires/requests heating (S310), whether the charger is available as a heat source (S320).

In S320, the facility heating device 100 using the electric vehicle charger heat source may determine that the heat source of the charger is available based on a temperature of the charger satisfying a threshold temperature (e.g., when the temperature of the charger reaches the threshold temperature or higher, such as while the charging station is charging the electric vehicle).

The specific temperature may be a predetermined temperature and/or may be determined based on one or more characteristics of the charger.

When/if the charger is operated at a temperature outside a specific temperature range, power loss may increase and/or charging safety is decreased. The threshold temperature may be determined in consideration of stable operation of the charger and/or power loss.

For example, the facility heating device 100 using the electric vehicle charger heat source may determine that the heat from the charger needs to be moved and/or discharged (e.g., to the facility 20) when/if the charger reaches the specific temperature.

The facility heating device 100 using the electric vehicle charger heat source may use the heat source of the charger by moving the heat generated by the charger to the heating load via a heat exchanger for cooling (e.g., when/if the charger satisfies the threshold temperature such as reaching the threshold temperature or higher).

The facility heating device 100 using the electric vehicle charger heat source may determine whether a phase change material (PCM) is available as a heat source (S330). The facility heating device 100 using the electric vehicle charger heat source may determine, based on the determination as to whether the facility uses/requires/requests heating (S310) and/or whether the charger is available as a heat source (S320), whether the PCM is available as the heat source (S330).

In S330, the facility heating device 100 using the electric vehicle charger heat source may determine whether sufficient heat energy is stored in the PCM.

When/if heat energy is stored in the PCM (e.g., in advance), the stored heat energy may be used for the heating load. To determine whether the PCM is available as a heat source, the temperature of the PCM may be checked.

The PCM may store heat energy while/via phase-changing in a specific temperature range. It may be determined that heat storage energy of the PCM is small at a reference temperature or lower (e.g., via a state/state change status of the PCM).

The facility heating device 100 using the electric vehicle charger heat source may determine that the PCM is available as a heat source based on the PCM temperature satisfying a reference temperature (e.g., when/if the temperature of the PCM is higher than the reference temperature).

The facility heating device 100 using the electric vehicle charger heat source may use (e.g., set, select for use, etc.) at least one of the heat source of the charger and the heat source of the PCM for heating the facility when the facility uses heating (S340).

In S340, the facility heating device 100 using the electric vehicle charger heat source may use the heat source of the PCM for heating the facility when it is determined that the heat source of the charger is not available when the facility uses heating.

The facility heating device 100 using the electric vehicle charger heat source may also or alternatively control use of an alternative heating source (e.g., radiator, heater, etc.) disposed in the facility for heating. The facility heating device 100 using the electric vehicle charger heat source may control use of the alternative heating source based on the charger and the PCM not being available as heat sources (when/if both the charger and the PCM are not available as heat sources).

The facility heating device 100 using the electric vehicle charger heat source may store heat energy generated by in the PCM by using the charger as the heat source when the heat source of the charger is available when the facility does not use heating (S350).

In S350, the facility heating device 100 using the electric vehicle charger heat source may control the charger to discharge heat and/or control the PCM to discharge heat (e.g., to the outside/environment) based on the facility not using/requiring/requesting heating (e.g., when the facility does not use/require/request heating).

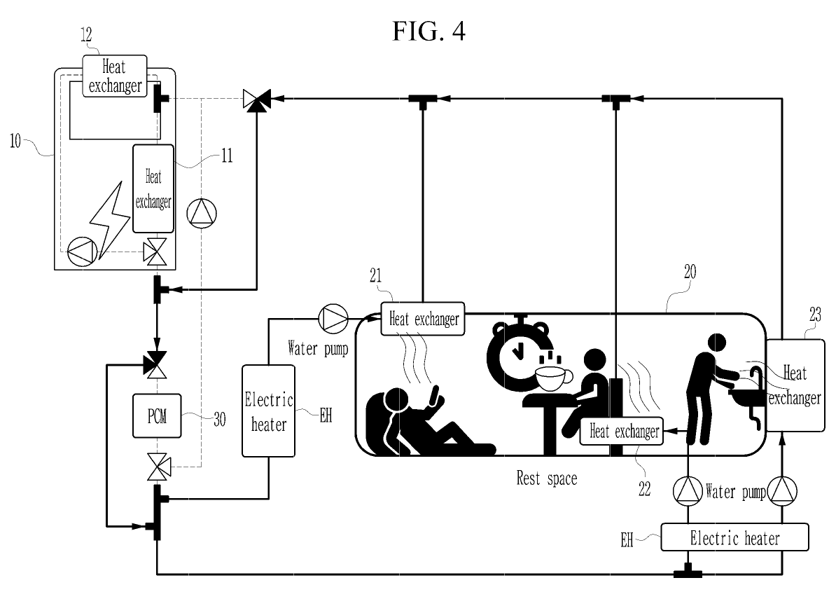

FIGS. 4 to 9 are circuit diagrams for describing the facility heating method using the electric vehicle charger heat source according to examples of the present disclosure.

FIG. 4 is a circuit diagram illustrating the flow of heat source and/or heat energy when/if it is determined that the heat source of the charger 10 is not available and the heat source of the PCM 30 is not available and when/if it is confirmed/determined that the multi-purpose facility 20 (hereinafter, the facility) uses heating.

In FIG. 4, the facility heating device 100 using the electric vehicle charger heat source may control the electric heater EH to provide required/requested heat (e.g., based on the charger and the PCM not being available as heat sources). For example, the electric heater EH may be used providing heat for the heating load of the facility 20. The electric heater EH may be connected to each of the third to fifth heat exchangers 21, 22, and 23.

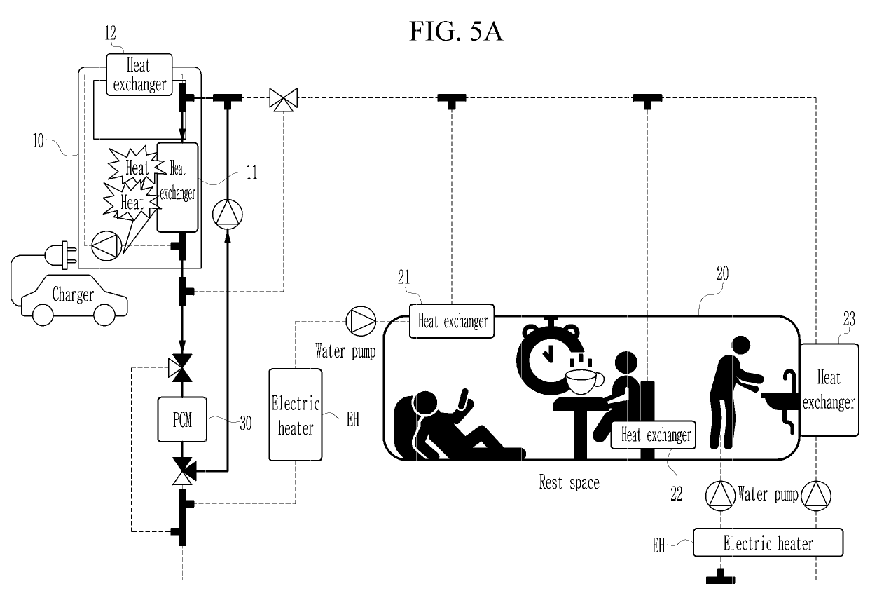

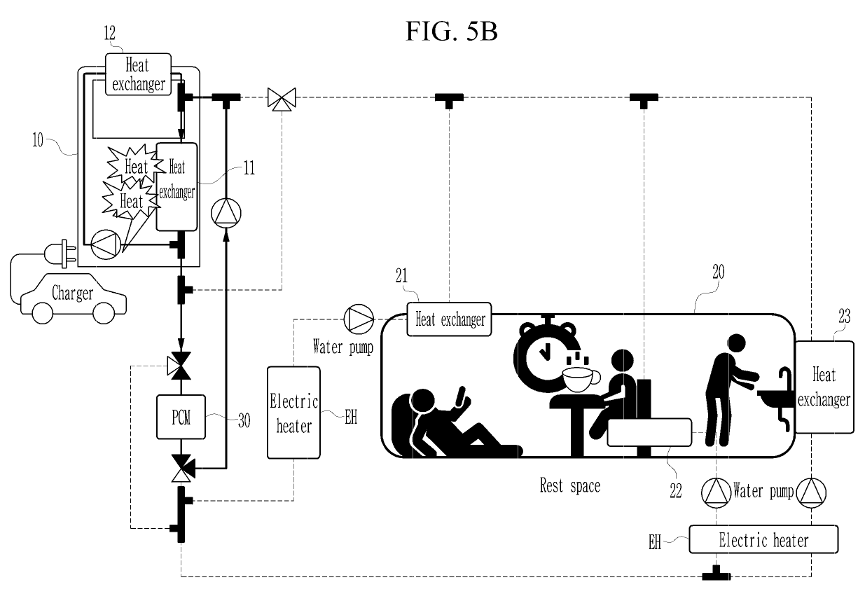

FIGS. 5A and 5B illustrate the flow of the heat source or heat energy when it is determined that the heat source of the charger 10 is available and the heat source of the PCM 30 is not available when the facility 20 does not use heating.

In FIG. 5A, the facility heating device 100 using the electric vehicle charger heat source may discharge the heat generated by the charger 10 to the PCM 30.

In FIG. 5B, when/if the process of storing the heat generated by the charger 10 as heat energy in the PCM 30 does not cause the temperature of the charger 10 to drop to a specific temperature or lower, the facility heating device 100 using the electric vehicle charger heat source may discharge some heat energy to the outside (e.g., instead of and/or while simultaneously storing heat energy in the PCM 30).

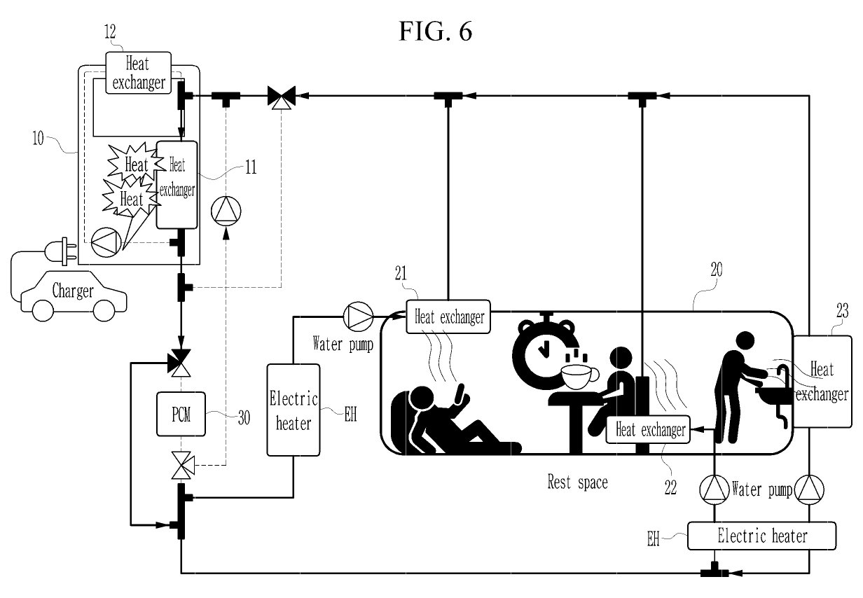

FIG. 6 illustrates the flow of the heat source or heat energy under the control of the facility heating device 100 using the electric vehicle charger heat source when the facility 20 uses heating. In particular, FIGS. 5A and 5B illustrate the flow of heat when/if it is determined that the heat source of the charger 10 is available as a heat source, and it is determined that the PCM 30 is not available as a heat source.

In FIG. 6, the facility heating device 100 using the electric vehicle charger heat source may detect the outside temperature satisfies an outside temperature (e.g., of a specific temperature (e.g., 0 degrees C, 10 degrees C, etc.) or lower and/or may determine that the facility 20 has a heating load (e.g., detect an occupant of the rest space, detects an attempt to use the hot water, etc.).

The facility heating device 100 using the electric vehicle charger heat source may determine that the heat source of the PCM 30 is not available based on the temperature of the PCM 30 not satisfying a threshold (e.g., when/if the temperature of the PCM 30 is the reference temperature or lower).

The facility heating device 100 using the electric vehicle charger heat source may use the heat source or heat energy generated by the charger 10 directly (e.g., without first storing in the PCM 30) for the heating load of the facility 20 when/if the temperature of the charger 10 satisfies (e.g., is equal to or higher than) a specific/threshold temperature.

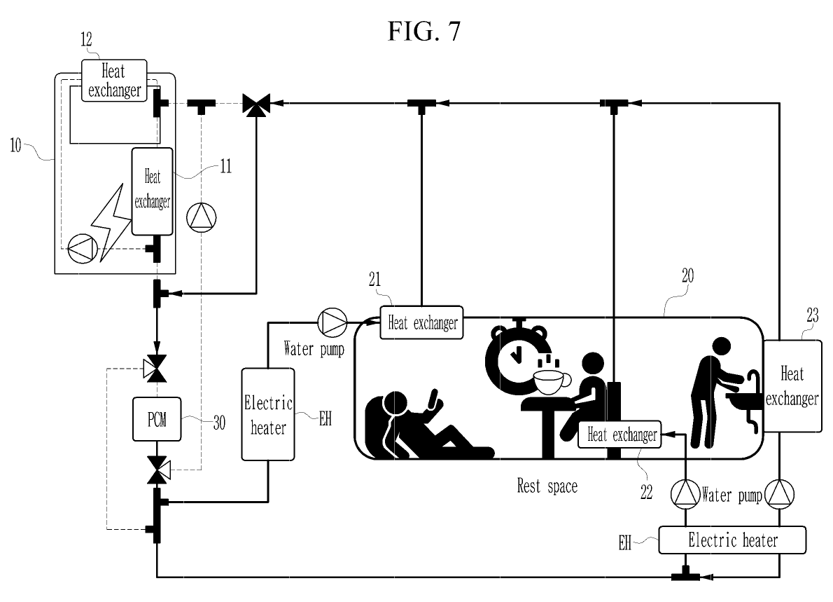

FIG. 7 illustrates the flow of the heat source or heat energy under the control of the facility heating device 100 using the electric vehicle charger heat source when the facility 20 uses heating, it is determined that the charger 10 is not available as a heat source, and it is determined that the PCM 30 is available as a heat source.

In FIG. 7, the facility heating device 100 using the electric vehicle charger heat source determines that the heat source of the PCM 30 is available when the temperature of the PCM 30 is equal to or higher than the reference temperature.

The facility heating device 100 using the electric vehicle charger heat source may use the PCM 30 for the heating load when/if the temperature of the charger 10 fails to satisfy the specific/threshold temperature (e.g., is equal to or lower than the specific temperature). For example, when/if the charger is not charging/has not recently charged the electric vehicle and/or when/if the heat generated by the charger is determined not to be used in consideration of charging efficiency while the charger charges the electric vehicle.

The facility heating device 100 using the electric vehicle charger heat source may respond to the heating load of the facility 20 by using the electric heater EH as an assistance/heat source (e.g., in addition to the charger 10 and/or the PCM 30), when/if the charger 10 and/or PCM 30 is insufficient as a heat source for heating the facility 20.

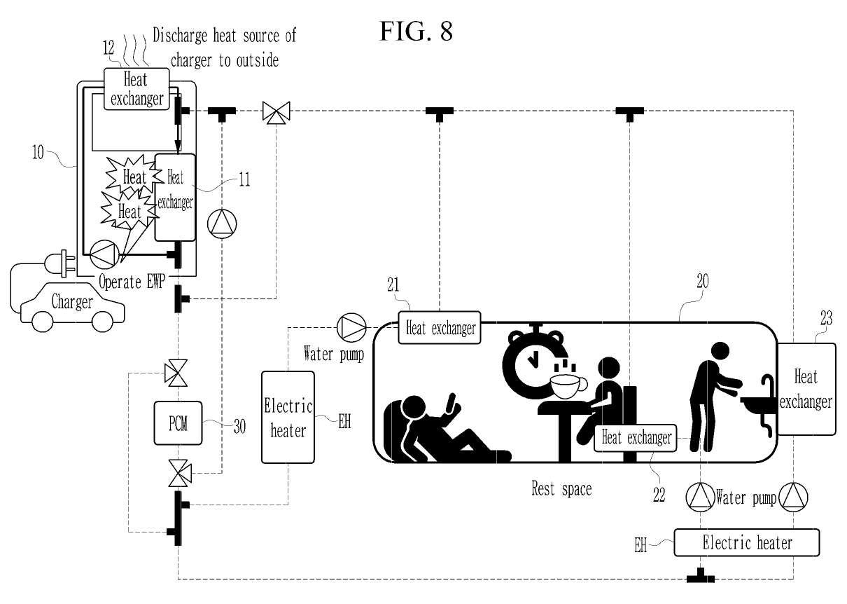

FIG. 8 illustrates the flow of the heat source and/or heat energy under the control of the facility heating device 100 using the electric vehicle charger heat source when the facility 20 does not use/require/request heating and/or it is determined that both the charger 10 and the PCM 30 are available as heat sources.

In FIG. 8, since heat storage energy is secured (e.g., because the temperature of the PCM 30 satisfies/is equal to or higher than the reference temperature), the facility heating device 100 using the electric vehicle charger heat source may discharge the heat generated by the charger to the outside (e.g., control the first and second heat exchangers 11 and 12 to discharge heat to the outside/environment).

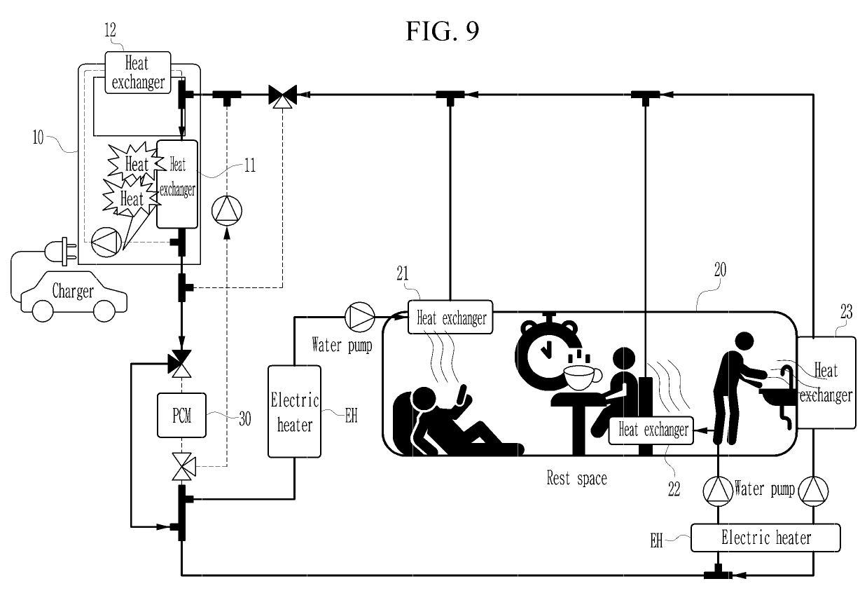

FIG. 9 illustrates the flow of the heat source and/or heat energy under the control of the facility heating device 100 using the electric vehicle charger heat source when the facility 20 uses heating, it is determined that the heat source of the charger 10 is available, and it is determined that the heat source of the PCM 30 is also available.

In FIG. 9, in the case where the outside temperature is equal to or lower than a specific/threshold outside temperature and the heating load of the facility 20 is not satisfied, the temperature of the PCM 30 satisfies (e.g., is equal to or higher than) the reference temperature and the heat storage energy is secured, and the temperature of the charger 10 satisfies (e.g., is equal to or higher than) a specific temperature (and thus the heat energy of the charger 10 needs to be discharged), the facility heating device 100 using the electric vehicle charger heat source may use the heat energy of the charger 10 and the heat storage energy of the PCM 30 to satisfy the heating load of the facility 20.

For example, the facility heating device 100 using the electric vehicle charger heat source may control/use the first and second heat exchangers 11 and 12 to move/cause movement of the heat energy of the charger 10 and/or the stored heat energy of the PCM 30 to the facility 20. The moved heat energy may be used for heating one or more loads via the third to fifth heat exchangers 21, 22, and 23 of the facility 20.

FIG. 10 is a diagram illustrating a computing device according to an example of the present disclosure.

Referring now to FIG. 10, the facility heating device and method using the electric vehicle charger heat source according to the examples may be implemented by using a computing device 900.

The computing device 900 may include at least one of a processor 910, a memory 930, a user interface input device 940, a user interface output device 950, and a storage device 560 communicating via a bus 920. The computing device 900 may also include a network interface 970 that is electrically connected to a network 90. The network interface 970 may transmit or receive a signal with another entity through the network 90.

The processor 910 may be implemented in various types, such as a Micro Controller Unit (MCU), an Application Processor (AP), a Central Processing Unit (CPU), a Graphic Processing Unit (GPU), a Neural Processing Unit (MPU), and the like, and may be a predetermined semiconductor device executing commands stored in the memory 930 or the storage device 960. The processor 910 may be configured to implement the functions and the methods described above with reference to FIGS. 1 to 9.

The memory 930 and the storage device 960 may include various forms of volatile or non-volatile storage media. For example, the memory may include a Read Only Memory (ROM) 931 and a Random Access Memory (RAM) 932. In the example, the memory 930 may be located inside or outside the processor 910, and the memory 930 may be connected with the processor 910 through already known various means.

In some examples, at least some configurations or functions of the facility heating device and method using the electric vehicle charger heat source according to the examples may be implemented as programs or software executed on the computing device 900, and the programs or software may be stored on a computer-readable medium.

In some examples, at least some configurations or features of the facility heating device and method using the electric vehicle charger heat source according to the examples may be implemented using hardware or circuit of the computing device 900, or may be implemented as separate hardware or circuit that may be electrically connected to computing device 900.

The present disclosure attempts to provide a facility heating device and method using an electric vehicle charger heat source that uses heat energy from an electric vehicle charger as heating or hot water heat energy in an electric vehicle charging cultural space.

The present disclosure attempts to provide a facility heating device and method using an electric vehicle charger heat source that use a charging heat source as a heat source for heating loads of a multi-purpose rest space (indoor heating air conditioning, hot water mat heat source supply, washstand hot water supply, etc.) when a charger temperature reaches a certain temperature or higher while an electric vehicle is being charged (i.e., cooling is required), charge a phase change material (PCM) with heat energy when there is a lot of heat energy in the charger, and discharge heat energy to outside air when charging is completed in the PCM.

An example of the present disclosure provides a facility heating method using an electric vehicle charger heat source, the facility heating method including: determining whether a facility uses heating; determining whether a heat source of a charger is available; determining whether a heat source of a phase change material (PCM) is available; and when the facility uses heating, using at least one of the heat sources of the charger and the heat source of the PCM for the heating of the facility.

The facility may include at least one multi-purpose facility which is adjacent to the charger, includes rest facilities or sales facilities, and is installed indoors or outdoors.

The determining of whether the facility uses heating may include determining whether the facility has at least one heating load, and the determining of whether the facility has at least one heating load may include determining that the facility uses heating when an outside temperature of the facility is lower than a specific temperature.

The determining of whether the heat source of the charger is available may include determining that the heat source of the charger is available when the temperature of the charger reaches a specific temperature or higher while the charging station is charging an electric vehicle.

The PCM may be a mixture of lauric acid, palmitic acid, and stearic acid.

The determining of whether the heat source of the PCM is available may include determining whether sufficient heat energy is stored in the PCM, and the determining of whether sufficient heat energy is stored in the PCM may include when a temperature of the PCM is higher than a reference temperature, determining that the heat source of the PCM is available.

The facility heating method may further include, when the facility does not use heating, storing heat energy in the PCM by using the heat source of the charger when the heat source of the charger is available.

The facility heating method may further include, using the heat source of the PCM for heating the facility when it is determined that the heat source of the charger is not available when the facility uses heating.

The facility heating method may further include, when the facility does not use heating, discharging heat from the heat source of the charger and the heat source of the PCM to the outside.

The facility heating method may further include, using a heating means disposed in the facility for the heating when the facility uses heating, and both the heat source of the charger and the heat source of the PCM are not available.

Another example of the present disclosure provides a facility heating device using an electric vehicle charger heat source, which uses heat energy from an electric vehicle charger as heat energy for heating an adjacent multi-purpose facility by executing a program code stored in one or more memory devices through one or more processors, in which the program code is executed to determine whether a facility uses heating, determine whether a heat source of a charger is available, determine whether a heat source of a phase change material (PCM) is available, and when the facility uses heating, use at least one of the heat sources of the charger or the heat source of the PCM for the heating of the facility.

The facility may include at least one multi-purpose facility which is adjacent to the charger, includes rest facilities or sales facilities, and is installed indoors or outdoors.

The determining of whether the facility uses heating may include determining whether the facility has at least one heating load, and determining that the facility has the at least one heating load when an outside temperature of the facility is lower than a specific temperature.

The determining of whether the heat source of the charger is available may include determining that the heat source of the charger is available when the temperature of the charger reaches a specific temperature or higher while the charger is charging an electric vehicle.

The PCM may be a mixture of lauric acid, palmitic acid, and stearic acid.

The determining of whether the heat source of the PCM is available may include determining whether sufficient heat energy is stored in the PCM, and when a temperature of the PCM is higher than a reference temperature, determining that sufficient heat energy is stored in the PCM.

The program code may be executed to, when the facility does not use heating, store heat energy in the PCM by using the heat source of the charger when the heat source of the charger is available.

The program code may be executed to use the heat source of the PCM for heating the facility when it is determined that the heat source of the charger is not available when the facility uses heating.

The program code may be executed to, when the facility does not use heating, discharge heat from the heat source of the charger and the heat source of the PCM to the outside.

The program code may be executed to use a heating means disposed in the facility for the heating when the facility uses heating, and both the heat source of the charger and the heat source of the PCM are not available.

The facility heating device and method using the electric vehicle charger heat source according to the example of the present disclosure may reduce costs by using heat energy from an electric vehicle charger as heating or hot water heat energy in an electric vehicle charging cultural space.

Although the above examples of the present disclosure have been described in detail, the scope of the present disclosure is not limited thereto, but also includes various modifications and improvements by one of ordinary skill in the art utilizing the basic concepts of the present disclosure as defined in the following claims.

What is claimed is:

1. A method performed by an apparatus for providing heat to a facility associated with a charger for an electric vehicle, the method comprising:
receiving, by at least one processor of the apparatus, a signal indicating a heating load of the facility;
determining, by the at least one processor, whether the charger is available as a heat source;
determining, by the at least one processor, whether a phase change material (PCM) is available as a heat source;
based on the indicated heating load and at least one of the charger or the PCM being available as at least one heat source, selecting, by the at least one processor, at least one of the charger or the PCM as a heat source for the heating load; and
transferring heat energy from the selected at least one of the charger or the PCM to the facility.

2. The method of claim 1, wherein:
the transferring of the heat energy comprises transferring, via a heat exchanger, the heat energy from the at least one of the charger or the PCM to the facility.

3. The method of claim 2, further comprising:
determining that the signal indicates the heating load based on the signal indicating that an outside temperature of the facility is lower than a threshold outside temperature.

4. The method of claim 1, wherein:
the determining of whether the charger is available comprises:
determining that the charger is available as a heat source based on:
a temperature of the charger satisfying a threshold charger temperature, and
the charger charging an electric vehicle.

5. The method of claim 1, wherein:
the PCM comprises a mixture of lauric acid, palmitic acid, and stearic acid.

6. The method of claim 1, wherein:
the determining of whether the PCM is available comprises:
determining, based on a temperature of the PCM satisfying a reference PCM temperature, that the PCM is available as a heat source.

7. The method of claim 1, further comprising:
based on the charger being available as a heat source and information indicating no heating load of the facility, storing heat energy, generated by the charger, in the PCM.

8. The method of claim 7, wherein the selecting the at least one of the charger or the PCM as the heat source for the heating load comprises:
based on the charger not being available as the heat source, selecting the PCM as the heat source and coupling the PCM to the heating load.

9. The method of claim 1, further comprising:
discharging, based on determining no heating load of the facility, heat energy from at least one of the charger or the PCM.

10. The method of claim 1, further comprising:
based on determining that the charger and the PCM are each not available as the heat source, controlling an electronic heater to satisfy the heating load.

11. A facility heating device configured to control use of heat energy from charger of an electric vehicle for heating a facility, the facility heating device comprising:
one or more processors; and
one or more memory devices storing a program code, wherein the program code, when executed by the one or more processors, is configured to cause the facility heating device to:
receive a signal indicating a heating load of the facility;
determine whether a charger is available as a heat source,
determine whether a phase change material (PCM) is available as a heat source,
based on the indicated heating load and at least one of the charger or the PCM being available as at least one heat source, select at least one of the charger or the PCM as a heat source for the heating load; and
transfer heat energy from the at least one of the charger or the PCM to the facility.

12. The facility heating device of claim 11, wherein:
the program code, when executed by the one or more processors, is configured to cause the facility heating device to transfer, via a heat exchanger, heat energy from the at least one of the charger or the PCM to the facility .

13. The facility heating device of claim 12, wherein the program code, when executed by the one or more processors, is configured to cause the facility heating device to:
determine that the signal indicates the heating load based on the signal indicating an outside temperature of the facility is lower than a threshold outside temperature.

14. The facility heating device of claim 11, wherein the program code, when executed by the one or more processors, is configured to cause the facility heating device to:
determine that the charger is available based on:
a temperature of the charger satisfying a threshold charger temperature, and
the charger charging an electric vehicle.

15. The facility heating device of claim 11, wherein the program code, when executed by the one or more processors, is configured to cause the facility heating device to:
determine, based on a temperature of the PCM satisfying a reference temperature, that the PCM is available as a heat source.

16. The facility heating device of claim 11, whereinthe program code, when executed by the one or more processors, is configured to cause the facility heating device to:
based on the charger being available as a heat source and information indicating no heating load of the facility, store heat, generated by the charger, in the PCM.

17. The facility heating device of claim 11, wherein the program code, when executed by the one or more processors, is configured to cause the facility heating device to:
select the at least one of the charger or the PCM as the heat source for the heating load by:
based on the charger not being available as the heat source, selecting the PCM as the heat source and coupling the PCM to the heating load.

18. The facility heating device of claim 11, wherein the program code, when executed by the one or more processors, is configured to cause the facility heating device to:
discharge, based on determining no heating load of the facility, heat from at least one of the charger or the PCM.

19. The facility heating device of claim 11, wherein the program code, when executed by the one or more processors, is configured to cause the facility heating device to:
based on determining that the charger and the PCM are each not available as the heat source, control an electric heater to satisfy the heating load.

20. A system comprising:
a charger for charging electric vehicles;
a phase change material (PCM) configured to receive heat from the charger;
one or more heat exchangers configured to exchange heat with the charger or the phase change material and provide the exchanged heat to a facility; and
a facility heating device comprising:
one or more processors; and
one or more memory devices storing a program code, wherein the program code, when executed by the one or more processors, is configured to cause the facility heating device to:
receive, from a sensor associated with the facility, a signal indicating a heating load of the facility;
determine whether at least one of the charger or the PCM is available as a heat source; and
based on the indicated heating load and the at least one of the charger or the PCM being available as the heat source:
setting the at least one of the charger or the PCM as the heat source;
coupling the at least one of the charger or the PCM to the heating load for heat transfer; and
controlling the one or more heat exchangers to exchange heat with the at least one of the charger or the PCM and provide the exchanged heat to the facility to satisfy the heating load.
